(19) United States
(12) Patent Application Publication
(10) Pub. No.: US 2007/0052673 A1
(43) Pub. Date: Mar. 8, 2007

(54) DISPLAY DEVICE

(75) Inventors: Kuo-Chou Chang, Miao-Li County (TW); Wei-Cheng Huang, Miao-Li County (TW)

Correspondence Address: J C PATENTS, INC., 4 VENTURE, SUITE 250, IRVINE, CA, 92618, US

(73) Assignee: CORETRONIC CORPORATION, Hsinchu (TW)

(21) Appl. No.: 11/466,543

(22) Filed: Aug. 23, 2006

(30) Foreign Application Priority Data
Sep. 6, 2005 (TW) 94215301

(51) Int. Cl. G09G 5/00

(52) U.S. Cl. 345/156

(57) ABSTRACT

A display device including a main body, a front plank and a hinge assembly is provided. The hinge assembly links the front plank and the main body. The hinge assembly includes a first component, a second component having protrusions and a third component having sleeves. The first component is disposed on the main body, the second component having protrusions is pivoted on the first component, and the third component having through holes for the sleeves to lodge in is disposed on the front plank. The protrusions sleeve to the sleeves detachably so that the front plank is easily assembled onto the main body.

### CROSS-REFERENCE TO RELATED APPLICATION

This application claims the priority benefit of Taiwan application serial no. 94215301, filed on Sep. 6, 2005. All disclosure of the Taiwan application is incorporated herein by reference.

### BACKGROUND OF THE INVENTION

1. Field of the Invention

The present invention relates to a display device. More particularly, the present invention relates to a display device with a front plank.

2. Description of the Related Art

Generally, a display device has a main body and a front plank disposed in front of the main body. The main body is used for displaying images; the front plank is used not only for decoration but also for covering inner components and interface outlets inside the display device and keeping the inner components and the interface outlets inside the display device from damage casing by entry of foreign objects.

The front planks of the conventional display devices are mostly fixed on the display devices with screws. When a display device needs to repair or change the inner components or install wires with the interface outlets, it is necessary to take off the screws fixed on the front plank first and then take away the front plank. Such work requires much time in assembling and disassembling the front plank. Another conventional front plank of the display device is directly hinged to the main body. When the front plank is opened for changing the inner components or installing wires with the interface outlets, the front plank is vulnerable to be impacted by its own gravity or by user's inadvertent force, resulting in damages of the front plank or the hinges.

### SUMMARY OF THE INVENTION

Accordingly, the present invention is directed to provide a display device. A front plank of the display device is easy to fix onto a main body of the display device.

Besides, the present invention is to provide a display device which has detachable protrusions and sleeves to keep a front plank or a hinge assembly of the display device from being damaged by impact force.

To achieve the above objects and others, the display device of the present invention includes a main body, a front plank and a hinge assembly. The hinge assembly links the front plank and the main body for pivoting the front plank to the main body. The hinge assembly includes a first component, a second component having a plurality of protrusions, and a third component having a plurality of sleeves. The first component is disposed on the main body, the second component is pivoted on the first component, and the third component has a plurality of through holes for the sleeves to lodge in and is disposed on the front plank. The protrusions sleeve to the sleeves detachably so that the front plank is easily fixed onto the main body. Besides, the sleeves, for example are formed integrally with the third component. The material of the sleeves and the protrusions is elastoplastic. In addition, the main body is a main body of a rear projection TV (RPTV) set.

The display device of the present invention has the detachable sleeves and the protrusions, and the front plank is sleeved to the main body through the elasticity of the sleeves and the protrusions. Thus, a user can easily take away the front plank from the display device or easily fix the front plank onto the display device. Besides, when the front plank is open and struck by an impact force, the sleeves and the protrusions separate from each other so that the front plank or the hinge assembly is not damaged by the force.

In order to make the aforementioned and other objects, features and advantages of the present invention comprehensible, a preferred embodiment accompanied with figures is described in detail below.

### BRIEF DESCRIPTION OF THE DRAWINGS

FIG. 1 is a schematic view of a display device in an embodiment of the present invention.

FIG. 2 is a schematic view of a hinge assembly shown in FIG. 1.

FIG. 3 is a schematic view of the hinge assembly fixed onto a front plank as shown in FIG. 1.

FIG. 4 is a schematic view of a hinge assembly in another embodiment of the present invention.

### DESCRIPTION OF PREFERRED EMBODIMENTS

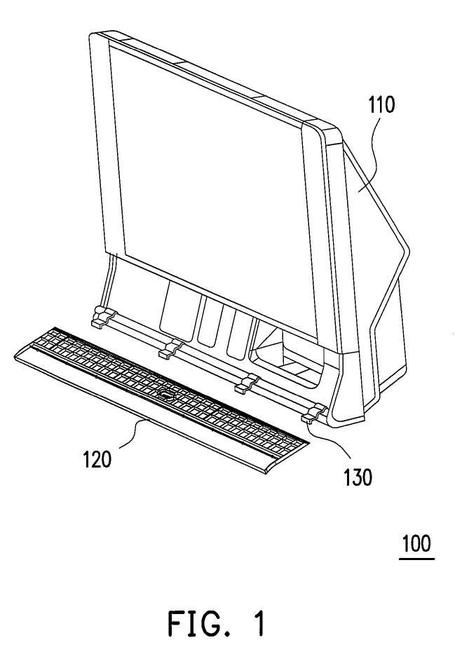

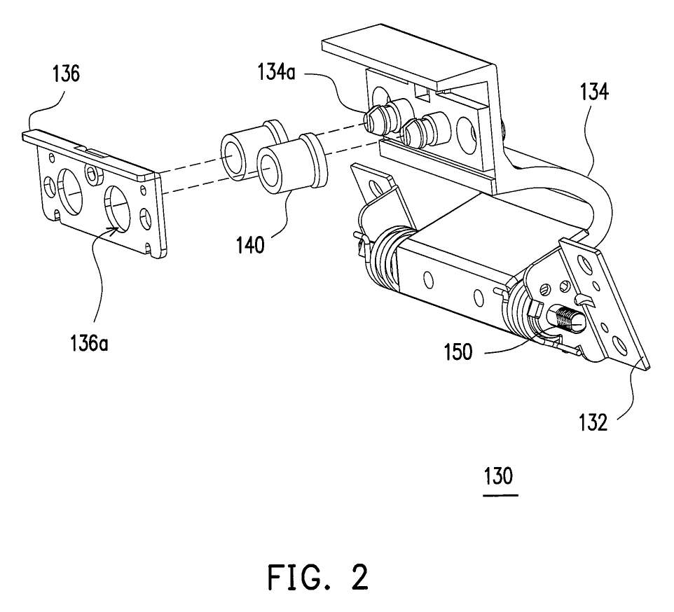

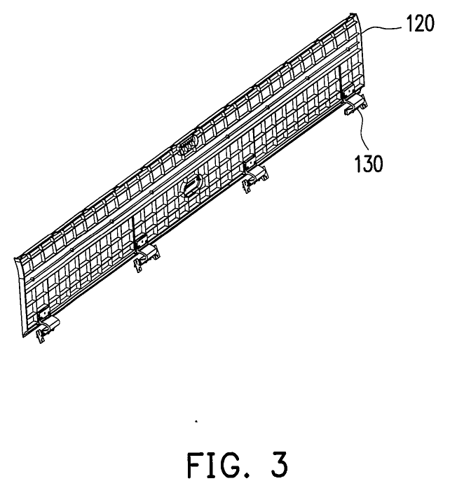

Referring to FIG. 1, a display device 100 according to an embodiment of the present invention includes a main body 110, a front plank 120 and a hinge assembly 130. The hinge assembly 130 links the front plank 120 and the main body 110 so that the front plank 120 is pivoted to the main body 110. Referring to FIG. 2, the hinge assembly 130 includes a first component 132, a second component 134, a third component 136 and at least one sleeve 140. The first component 132 is disposed on the main body 110. The second component 134 has at least one protrusion 134a and is pivoted on the first component 132. The third component 136 has at least one through hole 136a and is disposed on the front plank 120. The first component 132 is fixed onto the main body 110 with, for example, screws. The third component 136 is fixed onto the front plank 120 with, for example, screws as shown in FIG. 3.

Besides, the sleeve 140 is lodged in a through hole 136a, and the protrusions 134a is sleeved to the sleeve 140 detachably. In the present embodiment, the main body 110 is a main body of a rear projection TV set. The display device 100 also is other display devices with front planks 120. In more detail, one side of the second component 134 of the present embodiment is pivoted to the first component 132 by a way of a hinge 150, for example. Or the hinge 150 directly pivots the second component 134 onto the main body 110 without the first component 132 shown in FIG. 2.

Therefore, when the display device 100 needs to repair or change the inner components or install wires, because of the pivoting between the front plank 120 and the main body 110, a user only needs to open the front plank 120 to expose the inner components or the interface outlets (not shown). Thus, repairing, changing inner components or installing wires of the display device 100 become much easier.

The protrusion 134a is detachably sleeved to the sleeve 140 and is fitting for being lodged into the through hole 136a so that the second component 134 is detachably fixed onto the third component 136. Please note that the protrusion 134a and the sleeve 140 of the present embodiment are made of elastoplastic or other elastic materials. Therefore, when the sleeve 140 is lodged into the through hole 136a or the protrusion 134a is detachably sleeved to the sleeve 140, the deformation and the elasticity of the sleeve 140 and the protrusion 134a to achieve assembly and disassembly. Accordingly, the hinge assembly 130 of the present invention provides easy assembly of the front plank 120 onto the main body 110 or disassembly of the front plank 120 from the main body 110.

In addition, when the opened front plank 120 is struck by its own gravity or by the user's inadvertent force, the sleeve 140 and the protrusion 134a separate from each other so that the hinge assembly 130 or the front plank 120 are not easy to be damaged by the impact force.

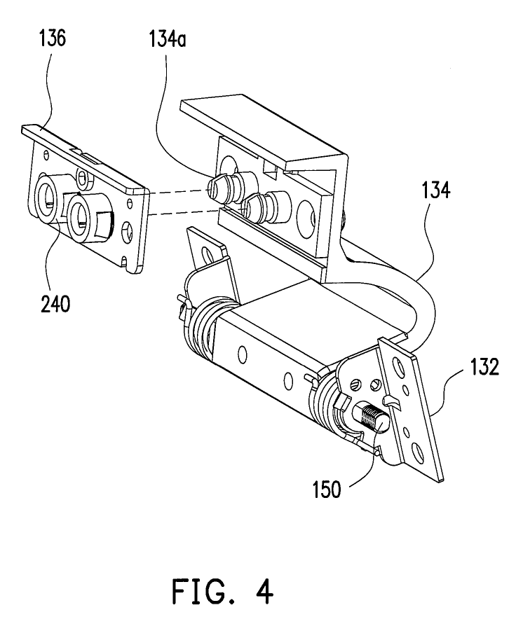

FIG. 4 is a schematic view of a hinge assembly in another embodiment of the present invention. In this embodiment, the sleeve 240 is formed integrally with the third component 136 so as to simplify the structure of the hinge assembly. Furthermore, it is also practicable that the sleeve 240 is formed integrally with the second component 134 and the protrusion is formed integrally with the third component, without the individual sleeve and protrusion shown in FIG. 2.

In summary, the front plank 120 of the display device in the present invention is pivoted onto the main body 110 through the hinge assembly 130. Thus, a user only needs to open the front plank 120 to examine the inside of the display device and to change or repair the inner components of the display device or install wires with the interface outlets. In addition, the sleeve design of the sleeve 140 and the protrusion 134a provides easy assembly of the front plank 120 onto the main body 110 or disassembly of the front plank 120 from the main body 110. Furthermore, when the opened front plank is struck by force, the sleeve and the protrusion separate from each other so that the front plank or the hinge assembly are not damaged by the impact force.

The present invention is disclosed above with its preferred embodiments. It is to be understood that the preferred embodiment of present invention is not to be taken in a limited sense. It will be apparent to those skilled in the art that various modifications and variations are made to the structure of the present invention without departing from the scope or spirit of the invention. The protection scope of the present invention is in accordance with the scope of the following claims and their equivalents.

What is claimed is:

1. A display device comprising:
a main body;
a front plank pivoted to the main body; and
at lease one hinge assembly linking the front plank and the main body for pivoting the front plank to the main body, the hinge assembly comprising:
a first component disposed on the main body;
a second component pivoted on the first component, the second component having at least one protrusion; and
a third component disposed on the front plank, the third component having at least one sleeve and the protrusion being sleeved to the sleeve detachably.

2. The display device as claimed in claim 1, wherein the third component has at least one through hole, and the sleeve is lodged in the through hole.

3. The display device as claimed in claim 1, wherein the sleeve is formed integrally with the third component.

4. The display device as claimed in claim 1, wherein a material of the sleeve and the protrusion is elastoplastic.

5. The display device as claimed in claim 1, wherein the main body is a main body of a rear projection TV set.

6. A display device comprising:
a main body;
a front plank; and
at lease one hinge assembly linking the front plank and the main body, the hinge assembly comprising:
a first component disposed on the main body;
a second component pivoted on the first component, the second component having at least one sleeve; and
a third component disposed on the front plank, the second component having at least one protrusion which is sleeved to the sleeve detachably.

7. The display device as claimed in claim 6, wherein, a material of the sleeve and the protrusion is elastoplastic.

8. A display device comprising:
a main body;
a front plank; and
at lease one hinge assembly linking the front plank and the main body for pivoting the front plank to the main body, the hinge assembly comprising:
a second component pivoted on the main body; and
a third component disposed on the front plank, the third component sleeved with the second component detachably.

9. The display device as claimed in claim 8, wherein the second component has at least one sleeve, and the third component has at least one protrusion sleeved to the sleeve detachably, so that the third component is sleeved with the second component detachably.

10. The display device as claimed in claim 9, wherein, a material of the sleeve and the protrusion is elastoplastic.

11. The display device as claimed in claim 8, wherein the third component has at least one sleeve, and the second component has at least one protrusion which is sleeved to the sleeve detachably, so that the third component is sleeved to the second component detachably.

12. The display device as claimed in claim 11, wherein a material of the sleeve and the protrusion is elastoplastic.
